(19) United States
(12) Patent Application Publication
(10) Pub. No.: US 2008/0011058 A1
(43) Pub. Date: Jan. 17, 2008

(54) PIEZORESISTIVE CANTILEVER BASED NANOFLOW AND VISCOSITY SENSOR FOR MICROCHANNELS

(75) Inventors: Ratnesh Lal, Goleta, CA (US); Ami Chand, Fremont, CA (US); Arjan Quist, Lombard, IL (US); Dan Cohen, Santa Barbara, CA (US)

Correspondence Address: BEYER WEAVER LLP, P.O. BOX 70250, OAKLAND, CA, 94612-0250, US

(73) Assignee: THE REGENTS OF THE UNIVERSITY OF CALIFORNIA, Oakland, CA (US)

(21) Appl. No.: 11/688,064

(22) Filed: Mar. 19, 2007

Related U.S. Application Data
(60) Provisional application No. 60/784,516, filed on Mar. 20, 2006.

(51) Int. Cl. G01N 11/10

(52) U.S. Cl. 73/54.23; 977/762; 977/842

(57) ABSTRACT

This invention provides a sensor to measure physical and/or chemical properties of viscous fluids. The sensor is based on microfabricated piezoresistive cantilevers. Deflection of these cantilevers is read out using, e.g., a wheatstone bridge to amplify and convert the deflection into a voltage output. The cantilevers and/or tips attached thereto, can be chemically or physically modified using reagents specific to interact with analytes to be detected in the fluid. The cantilevers can be integrated in a microfluidic system for easy fluid handling and the ability to manage small quantities of fluids.

### CROSS-REFERENCE TO RELATED APPLICATIONS

This application claims benefit of and priority to U.S. Ser. No. 60/784,516, filed on Mar. 20, 2006, which is incorporated herein by reference in its entirety for all purposes.

### STATEMENT AS TO RIGHTS TO INVENTIONS MADE UNDER FEDERALLY SPONSORED RESEARCH AND DEVELOPMENT

[Not Applicable]

### FIELD OF THE INVENTION

This invention pertains to the field of nano- or micro-instrumentation. Micro-fabricated piezoresistive microcantilevers are provided that have application in a wide variety of physical and/or chemical sensors.

### BACKGROUND OF THE INVENTION

A microfabricated cantilever is a major component of an atomic force microscope (AFM). Generally, the force interaction between the cantilevered AFM tip and the surface is measured by detecting the cantilever deflection, primarily using an optical beam deflection method, where a laser is bounced of the back of the cantilever into a position sensitive detector. Such sensors require external components, making the instrument more complicated. In liquid phase imaging, the laser beam used for optical detection could introduce additional heating and turbulence effects. An alternate and more compact system has the cantilever with an integrated piezoresistive sensor to measure the cantilever deflection (Linnemann et al. (1996) J. Vacuum Science & Technology B, 14: 856-860). Besides their use for AFM imaging, these cantilevers by themselves can also be used as a sensor for surface binding of analyte molecules, or to determine fluid viscosity. Viscosity measurement is important in many systems, ranging from the rheological behavior of paint (Osterhold (2000) Progress In Organic Coatings, 40: 131-137) ink-jet printing inks (de Gans et al. (2004) Macromolecular Rapid Communications, 25: 292-296), polymer melts and solutions for injection molding (Adhikari and Goveas (2004) J. Polymer Science Part B-Polymer Physics, 42: 1888-1904), as well as the biological fields, where viscosity information helps gain insight in kinematics of protein conformational changes and in blood rheology that contains important prognostic value for diagnostics and preventive medicine (Ernst et al. (1991) J. Internal Medicine, 229: 457-462).

Conventional micro-cantilever analyte sensors act in two ways. In the ac method a change in resonance frequency is measured due to a change in the cantilever mass. Disadvantages of this method include a lower Q-factor due to damping in fluid and a potential error due to the change of resonance frequency when the fluid viscosity changes. In the dc system, the bending of the cantilever due to surface stress is measured (Berger et al. (1997) Science, 276: 202 1-2024). Such cantilevers have been used for a wide range of applications, including, antibiotic-selective growth of bacteria on the cantilever (Gfeller et al. (2005) Applied And Environmental Microbiology, 71: 2626-263), polymer coated levers as alcohol vapor sensor (Jensenius et al. (2000) App. Physics Letts., 76: 2615-2617), specific antigen-antibody interaction measurement (Kooser et al. (2003) Biosensors & Bioelectronics, 19: 503-508), kinetics of alkanethiol monolayers self assembling on gold coated cantilevers (Berger et al. (1997) Science, 276: 202 1-2024), and to detect prostate specific antigen and C-reactive protein (Wee et al. (2005) Biosensors & Bioelectronics, 20: 1932-1938).

Measuring liquid viscosity with a high level of precision can be problematic. Several ultrasonic devices have been developed to measure liquid viscosity (Hauptmann et al. (1998) Sensors And Actuators A—Physical, 67: 32-48; Jakoby and Vellekoop (1998) Sensors And Actuators A-Physical, 68: 275-281; Lin et al. (1993) Analyt. Chem., 65: 1546-1551), but they operate at MHz frequency at which the viscosity of non-Newtonian fluids can be different than its low-frequency value that may be of more interest (Shih et al. (2001) J. Applied Physics, 89: 1497-1505). Flexural-mode resonance devices, such as microfabricated cantilevers may be more reliable, they potentially allow for viscosity measurement at lower frequencies. Piezoelectric cantilevers have been used to measure viscosity by monitoring frequency changes in different glycerol concentrations (Id.). These piezoelectric cantilevers have a lead zirconium titanate (PZT) layer on a large (4.9×0.6 cm) steel cantilever to actuate the oscillation at resonance frequency that is viscosity dependent. Similarly, using optical detection in standard AFM equipment, viscous drag has been measured using a piezoelectric actuator to vibrate an AFM silicon cantilever (Oden et al. (1996) Appl. Physics Letts., 68: 3814-3816). Other ways of using AFM to measure liquid viscosity include measuring the torsion in an AFM cantilever while scanning a whisker tip inside the liquid (Mechler et al. (2004) App. Physics Letts, 85: 3881-3883). Cantilevers and other MEMS devices have also been used as flow sensors. For instance, large (millimeter long) cantilevers that are curled into a flow device were produced by annealing metal coated levers (Kim et al. (2000) Japanese J. Applied Physics Part 1-Regular Papers Short Notes & Review Papers, 39: 7134-7137). Other flow sensors that can be integrated in microfluidic systems are based on measurement of electrical admittance (Collins and Lee (2004) Lab On A Chip, 4: 7-10), thermal sensors (Wu et al. (2001) Sensors and Actuators a-Physical 89: 152-158), and fiber optical methods that measure light reflected from a liquid/air interface (Szekely et al. (2004) Sensors and Actuators a-Physical, 113: 48-53).

A major advantage for using microfabricated piezoresistive levers is that they can be used to measure both flow and viscosity, and their small size allows for integration in a micro fluidic system. More importantly, such microlevers can be used in a conventional AFM system to obtain viscosity data on volumes as small as nanoliters. Additionally, a piezoresistive system with electrical readout would simplify the use of parallel cantilevers in a microfluidic channel array.

### SUMMARY OF THE INVENTION

In various embodiments this invention pertains to a new breed of piezoresistive cantilevers that are significantly more sensitive (by more than an order of magnitude) that are obtained by precision micromachining of existing piezoresistive cantilevers, as well as their use as flow sensors, comparative viscosity, and detectors for a wide variety of analytes. We show that commercially available focused ion beam machining services can be used to mill down the thickness, and minimize the spring constant of commercially available piezoresistive levers to obtain a greater mechanical sensitivity. The sensors are demonstrated to perform well as flow sensors, viscosity sensors, and chemical sensors.

Thus, in certain embodiments, a device for measuring physical and/or chemical properties of fluids or analytes in fluids at a nanoscale is provided. In certain embodiments the device comprises a piezoresistive microcantilever, the microcantilever having a spring constant of less than about 0.8 N/M, preferably less than about 0.6 N/m, more preferably less than about 0.4 N/m, still more preferably less than about 0.3 N/m. In various embodiments the microcantilever has a spring constant that ranges from about 0.05, 0.1, 0.15, or 0.2 N/m to about 0.3, 0.4, or 0.5 N/m. In various embodiments the microcantilever has a thickness of less than about 5.0 μm, preferably less than about 4.0 μm, more preferably less than about 3.0 μm, 2.5 μm, or 2.0 μm in at least one location. In certain embodiments the microcantilever comprises at least one lever of length less than about 100 μm, or less than about 75 μm, or less than about 50 μm, or less than about 40 μm, or 30 μm. In certain embodiments the microcantilever comprises at least one lever of length about 50 μm. In various embodiments the microcantilever comprises a material selected from the group consisting of silicon, carbon, germanium, tungsten, nickel, silicon nitride, and silicon oxide. In certain embodiments the device further comprises a sensing tip attached to the microcantilever. In certain embodiments the microcantilever has a spring constant at least five-fold less than the sensing tip, preferably at least 8-fold less than the sensing tip, more preferably at least 10-fold, or 12-fold, or 15-fold, or 20-fold, less than the sensing tip In certain embodiments the sensing tip comprises a carbon nanotube. In certain embodiments the sensing tip comprises a silicon structure. In certain embodiments the sensing tip comprises a carbon cone, a carbon nanotube, a nanowire, diamond, silicon nitride, silicon oxide, and the like. In various embodiments the microcantilever and/or sensing tip is coated with a magnetic or non-magnetic metal layer. In certain embodiments the metal layer functions as a chemical catalyst, a magnetic field sensor, or a capacitance sensor.

In various embodiments the cantilever and/or sensing tip is functionalized with an agent selected from the group consisting of a hydroxyl, an amino, a carboxyl, and a thiol and/or a binding moiety selected from the group consisting of a nucleic acid, an antibody, a polypeptide, a sugar, a lectin, a carbohydrate, a cell, a receptor, a small organic molecule, an avidin, a streptavidin, a biotin, and a protein. In various embodiments the sensing tip is disposed in a microchannel. In various embodiments the microchannel comprises a characteristic dimension (i.e., the dimension used for calculation of Reynold's number, e.g. diameter) of less than about 600 μm, preferably less than about 500 μm, more preferably less than about 450 μm, still more preferably less than about 400 μm, or less than about 300 μm, or less than about 250 μm. In various embodiments the microchannel comprises a cross-sectional area of less than about 0.20 mm², preferably less than about 0.18 mm², more preferably less than about 0.16 mm², still more preferably less than about 0.15 mm² or less than about 0.14 mm², or less than about 0.12 mm², or less than about 0.10 mm². In certain embodiments, the device comprises a plurality of microcantilevers (e.g., at least 2, preferably at least 5, more preferably at least 10, still more preferably at least 15, 20, 25, or 30 microcantilevers). In certain embodiments each of the plurality of microcantilevers bears a sensing tip. The sensing tips can be functionalized with agents that bind different analytes. In certain embodiments the device is coupled to an instrument to measure electrical resistance changes in the microcantilever(s).

In certain embodiments this invention provides a piezoresistive microcantilever, the microcantilever having a spring constant of less than about 0.8 N/M, preferably less than about 0.6 N/m, more preferably less than about 0.4 N/m, still more preferably less than about 0.3 N/m. In various embodiments the microcantilever has a spring constant that ranges from about 0.05, 0.1, 0.15, or 0.2 N/m to about 0.3, 0.4, or 0.5 N/m. In various embodiments the microcantilever has a thickness of less than about 5.0 μm, preferably less than about 4.0 μm, more preferably less than about 3.0 μm, 2.5 μm, or 2.0 μm in at least one location. In certain embodiments the microcantilever comprises at least one lever of length less than about 100 μm, or less than about 75 μm, or less than about 50 μm, or less than about 40 μm, or 30 μm. In certain embodiments the microcantilever comprises at least one lever of length about 50 μm. In various embodiments the microcantilever comprises a material selected from the group consisting of silicon, carbon, germanium, tungsten, nickel, silicon nitride, and silicon oxide. In certain embodiments the device further comprises a sensing tip attached to the microcantilever. In certain embodiments the microcantilever has a spring constant at least five-fold less than the sensing tip, preferably at least 8-fold less than the sensing tip, more preferably at least 10-fold, or 12-fold, or 15-fold, or 20-fold, less than the sensing tip In certain embodiments the sensing tip comprises a carbon nanotube. In certain embodiments the sensing tip comprises a silicon structure. In certain embodiments the sensing tip comprises a carbon cone, a carbon nanotube, a nanowire, diamond, silicon nitride, silicon oxide, and the like. In various embodiments the microcantilever and/or sensing tip is coated with a magnetic or non-magnetic metal layer. In certain embodiments the metal layer functions as a chemical catalyst, a magnetic field sensor, or a capacitance sensor.

In various embodiments this invention also provides methods of measuring the flow rate or viscosity of a fluid. The methods typically involve contacting the fluid with a device comprising a piezoresistive microcantilever as described herein; and measuring the electrical resistance or electrical conductivity of the microcantilever where the electrical resistance or electrical conductivity provides a measure of the deflection of the microcantilever which provides a measure of flow rate and/or viscosity of the fluid. In certain embodiments the fluid is in a microchannel. In certain embodiments the microchannel comprises a characteristic dimension (i.e., the dimension used for calculation of Reynold's number, e.g., diameter) of less than about 600 μm, preferably less than about 500 μm, more preferably less than about 450 μm, still more preferably less than about 400 μm, or less than about 300 μm, or less than about 250 μm. In various embodiments the microchannel comprises a cross-sectional area of less than about 0.20 mm², preferably less than about 0.18 mm², more preferably less than about 0.16 mm², still more preferably less than about 0.15 mm² or less than about 0.14 mm², or less than about 0.12 mm², or less than about 0.10 mm².

Methods are also provided for detecting the presence or quantity of one or more analytes in a fluid (e.g., gas or liquid). The methods typically involve contacting the fluid with a device comprising a piezoresistive microcantilever as described herein where the microcantilever is functionalized with an agent that binds the analyte, and/or the microcantilever is attached to a sensing tip that is functionalized with an agent that binds the analyte; and detecting deflection of the microcantilever where deflection of the microcantilever provides a measure of presence or amount of analyte bound to the tip. In certain embodiments the detecting comprises detecting the conductance or resistivity of the microcantilever. In various embodiments the microcantilever and/or tip is functionalized with an agent selected from the group consisting of a hydroxyl, an amino, a carboxyl, and a thiol and/or a binding moiety selected from the group consisting of a nucleic acid, an antibody, a polypeptide, a sugar, a lectin, a carbohydrate, a cell, a receptor, a small organic molecule, an avidin, a streptavidin, a biotin, and a protein. In certain embodiments contacting is in a microchannel or microchamber as described herein.

Methods of fabricating a piezoresistive microcantilever are also provided. The methods typically involve providing a device layer on a substrate where the device layer comprises a microcantilever; and micromachining the microcantilever to dimensions providing a spring constant of less than about 0.6 N/m, more preferably less than about 0.4 N/m, still more preferably less than about 0.3 N/m. In various embodiments the microcantilever is machined to dimensions that provide a spring constant that ranges from about 0.05, 0.1, 0.15, or 0.2 N/m to about 0.3, 0.4, or 0.5 N/m. In various embodiments the microcantilever is machined to a thickness of less than about 5.0 μm, preferably less than about 4.0 μm, more preferably less than about 3.0 μm, 2.5 μm, or 2.0 μm in at least one location. In certain embodiments the microcantilever is fabricated to comprise at least one lever of length less than about 100 μm, or less than about 75 μm, or less than about 50 μm, or less than about 40 μm, or 30 μm. In certain embodiments the micromachining comprises micro-milling using a focused ion beam. In certain embodiments the method further comprises depositing a sensing tip attached to the microcantilever. In certain embodiments the sensing tip comprises a carbon nanotube or a nanowire.

### DEFINITIONS

The term “antibody”, as used herein, includes various forms of modified or altered antibodies, such as an intact immunoglobulin, an Fv fragment containing only the light and heavy chain variable regions, an Fv fragment linked by a disulfide bond (Brinkmann et al. (1993) Proc. Natl. Acad. Sci. USA, 90: 547-551), an Fab or (Fab)′2 fragment containing the variable regions and parts of the constant regions, a single-chain antibody and the like (Bird et al. (1988) Science 242: 424_{—}426; Huston et al. (1988) Proc. Nat. Acad. Sci. USA 85: 5879_{—}5883). The antibody may be of animal (especially mouse or rat) or human origin or may be chimeric (Morrison et al. (1984) Proc Nat. Acad. Sci. USA 81: 6851-6855) or humanized (Jones et al. (1986) Nature 321: 522-525, and published UK patent application #8707252).

The terms “binding partner”, or “capture agent”, or a member of a “binding pair” refers to molecules that specifically bind other molecules to form a binding complex such as antibody-antigen, lectin-carbohydrate, nucleic acid-nucleic acid, biotin-avidin, etc.

The term “specifically binds”, as used herein, when referring to a biomolecule (e.g., protein, nucleic acid, antibody, etc.), refers to a binding reaction which is determinative of the presence biomolecule in heterogeneous population of molecules (e.g., proteins and other biologics). Thus, under designated conditions (e.g. immunoassay conditions in the case of an antibody or stringent hybridization conditions in the case of a nucleic acid), the specified ligand or antibody binds to its particular “target” molecule and does not bind in a significant amount to other molecules present in the sample.

The term “preferentially binds” refers to a moiety that binds to a particular target with greater affinity or avidity than to other targets present in the same sample. Preferential binding thus provides a means by which the presence and/or quantity of the target analyte (e.g., a particular IgE) is present in a sample.

The term “sample” or “biological sample” when used herein in reference, e.g. to an allergy assay refers to a sample of a biological material that typically contains IgE antibodies. Such samples include, for example, whole blood, serum, etc. The sample can be a “raw” sample simply as taken from a subject or the sample can be processed, e.g. to remove cellular debris.

### BRIEF DESCRIPTION OF THE DRAWINGS

FIG. 1 schematically illustrates one microcantilever device 02 according to the present invention.

FIG. 2 schematically illustrates one microcantilever device of this invention set up to detect fluid flow and/or analytes in a microchannel.

FIG. 3 illustrates SEM images of an FIB machined piezoresistive cantilever. The two legs of the cantilever are milled down along a 70-75 micrometer length to a thickness of 1.7 micrometer (original thickness 2.7 micrometer) leaving the paddle part of the cantilever unchanged. This results in a more sensitive bending-hinge.

FIG. 4 shows amplified Wheatstone bridge output as function of z position of the AFM scanner. A 1 Hz ramp signal was applied. Top panel: 500 nm z-movement; Middle panel: 10 nm z-movement. The bottom panel shows a plot of Wheatstone bridge output as function of bending. The line is a linear curve fit indicating 0.15 mV output per nm deflection, with a minimum detectable deflection of 6 nm (noise level around 1 mV).

FIG. 5 shows amplifier output for different viscosity fluids at 20° C. At time t=0 the flow is started, and the flow is switched of after a stable reading is obtained (around t=90-100 s). In between each fluid, the system is rinsed with 5 ml of water. Viscosities (table values) are: water, 1 cP; 25% Ethylene Glycol, 1.5 cP; 50% EG, 2.8 cP; 75% EG, 7.0 cP, and 100% EG, 14 cP. It takes up to 1 minute to reach a stable reading and cantilever bending. The flow speed is 1 ml/min, equivalent to a speed in the syringe needle of 12 cm/sec. Thus only 1 ml of fluid is needed. The bottom panel shows voltage response versus viscosity, based on known viscosity of different EG concentrations.

FIG. 6 shows a comparison of voltage readout at different flow speeds. To guide the eye, points are connected by lines. At low flow speed, higher viscosity fluids such as ethylene glycol saturate the amplifier. At higher flow speeds (300 mm/sec equals 3 ml/min) the sensor distinguished between DMEM buffer with 5% and 50% Fetal Bovine Serum. The protein content of blood serum is a major contributor to the viscosity of biological fluids.

FIG. 7 illustrates representative Wheatstone bridge circuitry. The bridge output is balanced using a variable resistor to accommodate for small differences in resistance in different cantilevers.

FIG. 8 illustrates a setup of the stainless steel needle (top) and silicon channels (bottom). The cantilever is inserted and aligned using a micromanipulator and held with the base nearly touching the upper edge of the channel opening. The left side shows side views, the right side shows a front view looking into the channel.

FIG. 9 illustrates a synthesis protocol for fabrication of a microcantilever device.

FIG. 10 illustrates one microcantilever array 16 of this invention.

### DETAILED DESCRIPTION

In various embodiments, this invention pertains to the development of novel microcantilever devices comprising single microcantilevers or microcantilever arrays. In various embodiments the microcantilevers are extremely small piezoresistive devices that achieve a high degree of sensitivity providing an easily detectable signal in response to a very low force.

The microcantilever devices of this invention can be used in a wide variety of contexts including, but not limited to the measurement of various physical and chemical properties of various fluids and/or analytes in fluids at nanoscale. For example, the force exerted by fluid flow (e.g. in a microchannel) can be sensed by deflection of one or more microcantilevers of this invention. Using this force measurement, flow rate and/or viscosity of the subject fluid can be measured. Similarly, the microcantilever can simply be used to indicate the presence and/or flow of a fluid through a microchannel (e.g., in a microfluidic device such as a “lab on a chip”).

In certain embodiments, the microcantilevers, and/or sensing tips attached to the microcantilevers can be functionalized to sense specific physical properties (e.g., electric field, magnetic field, viscoelastic properties, fluid mechanics, physical dimensions of the solutes, long range forces, e.g., electrostatic and Van der Waals), and/or chemical properties (e.g., chemical nature of the solvents and solutes, chemisorption, etc).

The interactions of the sensor (microcantilever and/or microcantilever sensor tip) with the fluid or analytes within the fluid will lead to physical alteration in the dimensions (primarily the deflection) of the sensor. The sensor deflection is typically by a piezoresistive detector so that deflection is measured as a change in the resistance of the elements. The electrical signal thus generated can be translated into the mechanical properties of the fluids such as velocity, viscosity etc. and/or presence or amount of particular analytes.

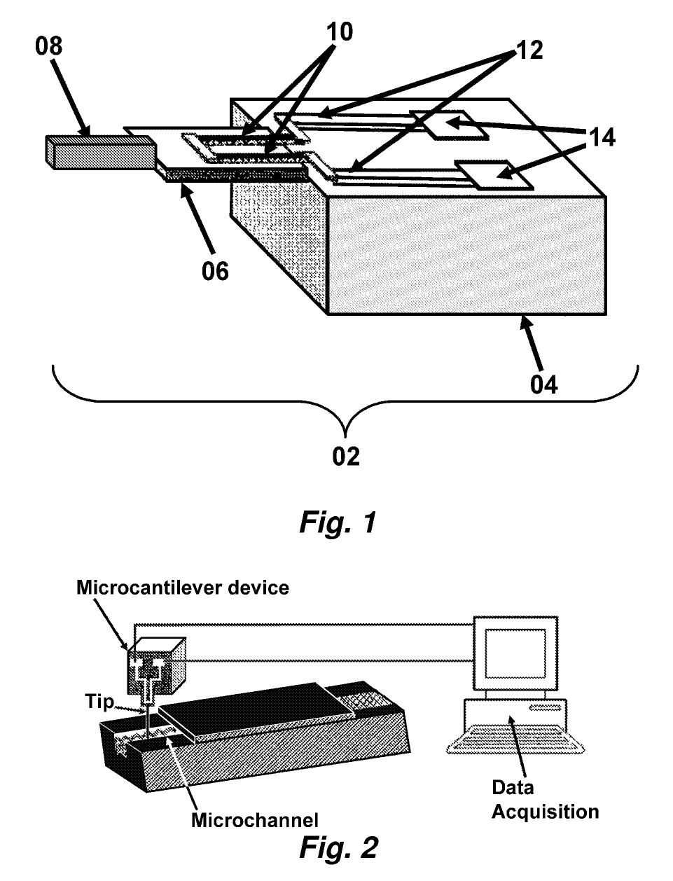

In certain embodiments the microcantilever 06 comprises a sensing tip 08 attached to a piezoresistive element 10 as shown FIG. 1. In certain embodiments the width of the sensing tip is less than 30 nm. The piezoresistive element assembly can be embedded in cantilever 06 (e.g. a silicon cantilever) that, in various embodiments, has at least an order of magnitude smaller spring constant than the sensing tip. The sensing tip and the piezoresistive cantilever can be the same plane and attached to a mounting block 04 made of, for example, silicon. Electrical connections are made to the piezoresistive elements 10 through contact lines 12 and contact pads 14.

One embodiment of the setup is shown in FIG. 2. The sensing tip is inserted in the channel containing a fluid in motion. The width of the channel could be in the range of the width of the sensing tip. The fluid in motion exerts force on the tip and deflects it. The deflection results into bending of the piezoresistive assembly. The change in the resistance is recorded as a function of deflection.

In certain embodiments the sensing tip is made of silicon, germanium, carbon, a carbon nanotube, a nanofiber, a nanowire, and the like. The sensing tip (e.g. carbon nanotube) can be functionalized to so the device can detect a wide range of analytes. Since the process to produce the device is compatible to batch fabrication, an array of such elements can be attached to one mounting block for parallel sensing and detection

I. Device Fabrication.

The microcantilever(s) and microcantilever devices of the present invention can be manufactured using a variety of microfabrication techniques, and are typically fabricated utilizing a combination of deposition (e.g. CVD) and micromachining (etching) methods.

Various deposition methods can be used to build up layers comprising the microcantilever devices of this invention. Such deposition methods include, but are not limited to chemical vapor deposition (CVD), plasma-assisted vapor deposition, and electron beam evaporation deposition, focused ion beam deposition, and the like.

Focused ion beam (FIB) operate in a similar fashion to a scanning electron microscope (SEM) except, rather than a beam of electrons and as the name implies, FIB systems use a finely focused beam of ions (e.g., gallium ions) that can be operated at low beam currents for imaging or high beam currents for site specific sputtering or milling.

In various embodiments surface etching methods, used in IC production for defining thin surface patterns in a semiconductor wafer, can be modified to allow for sacrificial undercut etching of thin layers of semiconductor materials to create movable elements. Bulk etching, typically used in IC production when deep trenches are formed in a wafer using anisotropic etch processes, can be used to precisely machine edges or trenches in microdevices. Both surface and bulk etching of wafers can proceed with “wet processing”, using chemicals such as potassium hydroxide in solution to remove non-masked material from a wafer. For microdevice construction, it is even possible to employ anisotropic wet processing techniques that rely on differential crystallographic orientations of materials, or the use of electrochemical etch stops, to define various channel elements.

Another etch processing technique that allows great microdevice design freedom is commonly known as “dry etch processing”. This processing technique is particularly suitable for anistropic etching of fine structures. Dry etch processing encompasses many gas or plasma phase etching techniques ranging from highly anisotropic sputtering processes that bombard a wafer with high energy atoms or ions to displace wafer atoms into vapor phase (e.g. ion beam milling), to somewhat isotropic low energy plasma techniques that direct a plasma stream containing chemically reactive ions against a wafer to induce formation of volatile reaction products.

Intermediate between high energy sputtering techniques and low energy plasma techniques is a particularly useful dry etch process known as reactive ion etching. Reactive ion etching involves directing an ion containing plasma stream against a semiconductor, or other, wafer for simultaneous sputtering and plasma etching. Reactive ion etching retains some of the advantages of anisotropy associated with sputtering, while still providing reactive plasma ions for formation of vapor phase reaction products in response to contacting the reactive plasma ions with the wafer. In practice, the rate of wafer material removal is greatly enhanced relative to either sputtering techniques or low energy plasma techniques taken alone. Reactive ion etching therefore has the potential to be a superior etching process for construction of microdevices, with relatively high anistropic etching rates being sustainable. The micromachining techniques described above, as well as many others, are well known to those of skill in the art (see, e.g., Choudhury (1997) The Handbook of Microlithography, Micromachining, and Microfabrication, Soc. Photo-Optical Instru. Engineer, Bard & Faulkner (1997) Fundamentals of Microfabrication). In addition, examples of the use of micromachining techniques on silicon or borosilicate glass chips can be found in U.S. Pat. Nos. 5,194,133, 5,132,012, 4,908,112, and 4,891,120.

In one embodiment, the channel is micromachined in a silicon wafer using standard photolithography techniques to pattern the cantilever, chambers, optional channels, sample processing chambers, connection ports, and the like. In certain embodiments ethylene-diamine, pyrocatechol (EDP) can be used for a two-step etch and a Pyrex 7740 coverplate can be anodically bonded to the face of the silicon to provide a closed liquid system. In this instance, liquid connections can be made on the backside of the silicon.

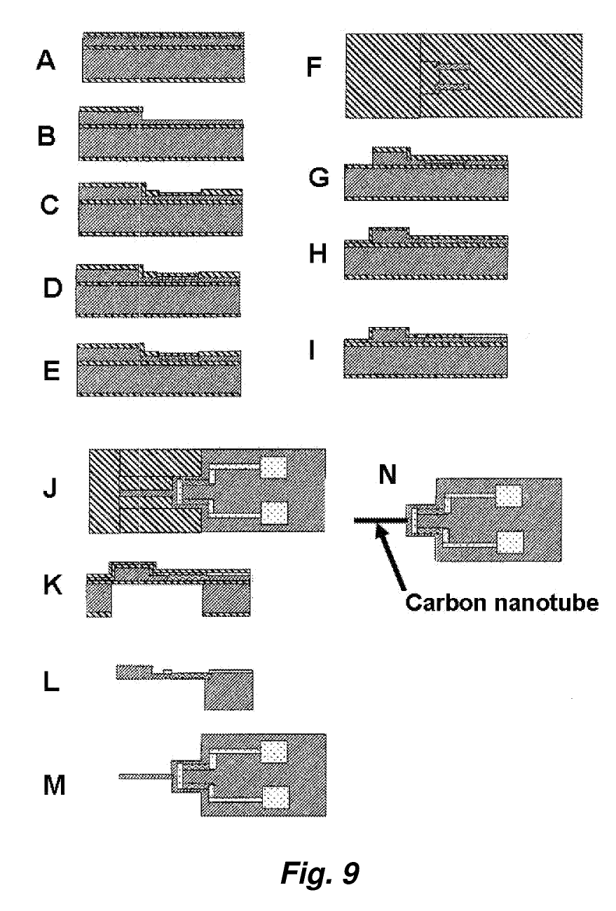

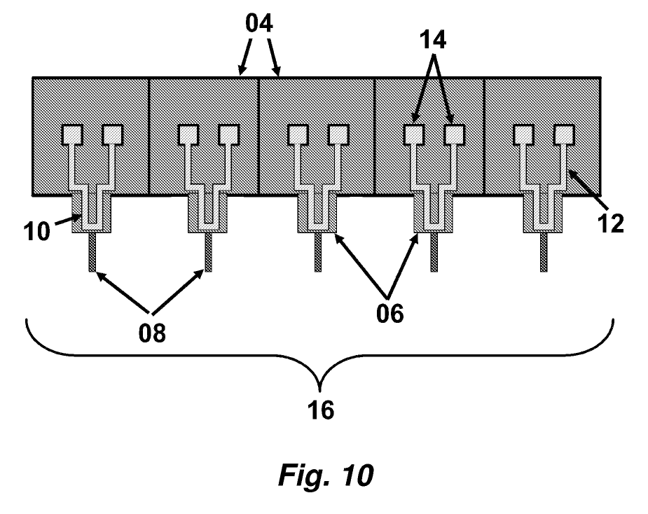

In certain embodiments the microcantilever devices of this invention can be produced using the following illustrative steps (see, e.g., FIG. 9, panels A-N):

A) In one illustrative embodiment, the substrate is composed of a silicon-on-insulator (SOI) or single crystal silicon wafer. The process here pertains to a silicon-on-insulator (SOI) wafer. The thickness of the silicon device layer( top layer) is determined by the thickness of the sensing tip. In this embodiment, since piezoresistive elements are defined using boron ion implantation, an n-type silicon device layer is used for isolation purposes. A silicon dioxide layer of, e.g., 1000 \acute{Å} is thermally grown on the substrate as illustrated in FIG. 9, panel A.

B) The silicon surface(s) in selected area(s) for piezoresistive assembly are exposed using standard photolithography process. The silicon dioxide layer can be etched in buffered hydrofluoric acid with photoresist as a mask and the silicon can be etched with dry or wet silicon etches chemistry using, e.g., oxide as mask. A cross sectional view of this step is shown in FIG. 9, panel B. The targeted thickness of the silicon is calculated from the desired spring constant of the piezoresistive assembly block.

C) The silicon dioxide layer is stripped and a fresh, e.g., 1 μm thick oxide layer is thermally grown. A photolithographic step is performed to open windows in the oxide layer to facilitate boron ion implantation for piezoresistive assembly. As shown in FIG. 9, panel C, an additional thin oxide layer (e.g., 1000 A) is grown primarily to cover the exposed silicon areas before the boron ion implantation is carried out. A boron ion implantation can be carried out followed by a drive-in step at e.g., 1000° C. to activate and define the boron resistors. These steps are shown in FIGS. 9, panels D and E, respectively. A top view of the substrate depicting the piezoresitive elements are shown in FIG. 9, panel F.

D) A sensing tip is defined using e-beam photolithography process. A dry etch process is used to etch silicon and is stopped at the buried oxide layer of the SOT substrate as shown in FIG. 9, panel G. The masking oxide layer is stripped and a fresh layer of oxide is grown to cover all the exposed area of silicon as shown in FIG. 9, panel H.

E) The metal contact pad(s) and the connecting line patterns are defined through a lift-off process step. In this step a positive photoresist covers all areas except the pad and the connecting lines. The contact areas are opened by etching the oxide under layer. A metal layer such as Al or Cr/Au is deposited. The substrate is then dipped in organic solvent such as acetone to remove the photoresist. The metal layer covering the photoresist is also lifted in the process. The pad and the connecting lines are the thereby defined. A cross sectional view of the substrate is shown in FIG. 9, panel I. The top view is shown in FIG. 9, panel J.

F) The substrate is flipped over to perform a backside lithography step to integrate the mounting block, sensing tip and piezoresistive assembly. Using oxide as the mask the mounting block is etched in a deep reactive ion etching (DRIE) system while protecting the front side with a layer of photoresist (not shown). The deep RfE process is stopped at the buried oxide layer as shown in FIG. 9, panel K.

G) The photoresist protecting layers on the front side is removed in oxygen plasma and the front and buried oxide layers are stripped completely to release the device. A cross sectional and top view of the final device is shown respectively in FIG. 9, panels L and M.

The steps described above are for a batch fabrication process. In certain embodiments the device can contain an array of sensing tips. Since the piezoresistive element and the tip are in the same plane, the dimensions and shape of the tip can be manipulated easily.

The sensing tip may be produced from different materials such carbon nanotube, nanofibers, nanowires, and the like. In certain embodiments a modification at step (D) may replace the silicon sensing tip with carbon nanotube deposition.

These steps are merely illustrative of one fabrication process. Utilizing the teachings provided herein, other fabrication methods will be available to those of skill in the art.

II. Functionalization.

In various embodiments, the microcantilever(s) and/or sensing tips attached to the microcantilevers are functionalized to facilitate the detection of one or more analytes. Typically this involves attaching a binding partner (capture agent) to the microcantilever and/or to a sensing tip attached to the microcantilever. Where chemical detection is desired, the microcantilever and/or sensing tip may simply be functionalized to present one or more reactive groups, e.g., a hydroxyl, an amino, a carboxyl, a thiol, etc.

Various other binding partners include, but are not limited to a nucleic acid, an antibody, a polypeptide, a sugar, a lectin, a carbohydrate, a cell, a receptor, a small organic molecule, an avidin, a streptavidin, a biotin, a protein, and the like.

Means for functionalizing surfaces to present reactive groups or biomolecules and the like are well known to those of skill in the art. In the case of various biomolecules, the desired capture agent can be covalently bound, or noncovalently attached through specific or nonspecific bonding.

If covalent bonding between a compound and the surface is desired, the surface will usually be polyfunctional or be capable of being polyfunctionalized. Functional groups which may be present on the surface and used for linking can include carboxylic acids, aldehydes, amino groups, cyano groups, ethylenic groups, hydroxyl groups, mercapto groups and the like. The manner of linking a wide variety of compounds to various surfaces is well known and is amply illustrated in the literature. See, for example, Ichiro Chibata (1978) Immobilized Enzymes, Halsted Press, New York, and Cuatrecasas, (1970) J. Biol. Chem. 245: 3059.

In addition to covalent bonding, various methods for noncovalently binding a component (e.g. an antigen) can be used. Noncovalent binding is typically nonspecific absorption of a compound to the surface. In various embodiments the cantilever surface is blocked with a second compound to prevent nonspecific binding of target. Alternatively, the surface is designed such that it nonspecifically binds one component but does not significantly bind another. For example, a surface bearing a lectin such as concanavalin A will bind a carbohydrate containing compound but not a labeled protein that lacks glycosylation. Various solid surfaces for use in noncovalent attachment of assay components are reviewed in U.S. Pat. Nos. 4,447,576 and 4,254,082.

In certain embodiments, the binding moiety (e.g., antigen, anti-IgE antibody, etc.) is immobilized on the cantilever(s) by the use of a linker (e.g. a homo- or heterobifunctional linker). Linkers suitable for joining biological binding partners are well known to those of skill in the art. For example, a protein or nucleic acid molecule may be linked by any of a variety of linkers including, but not limited to a peptide linker, a straight or branched chain carbon chain linker, or by a heterocyclic carbon linker. Heterobifunctional cross linking reagents such as active esters of N-ethylmaleimide have been widely used (see, for example, Lerner et al. (1981) Proc. Nat. Acad. Sci. USA, 78: 3403-3407 and Kitagawa et al. (1976) J. Biochem., 79: 233-236, and Birch and Lennox (1995) Chapter 4 in Monoclonal Antibodies: Principles and Applications, Wiley-Liss, N.Y.).

In one embodiment, the antigen, binding moiety, or antibody is immobilized on the cantilever or sensing tip utilizing a biotin/avidin interaction. In one approach, biotin or avidin with a photolabile protecting group can be attached to the cantilever surface. Irradiation of the distinct cantilevers results in coupling of the biotin or avidin to the illuminated cantilever(s) at that location. Then, the antigen or other binding moiety, bearing a respective biotin or avidin is placed into the channel whereby it couples to the respective binding partner and is localized on the irradiated cantilever. The process can be repeated at each distinct location it is desired to attach a binding partner.

Another suitable photochemical binding approach is described by Sigrist et al. (1992) Bio/Technology, 10: 1026-1028. In this approach, interaction of ligands with organic or inorganic surfaces is mediated by photoactivatable polymers with carbene generating trifluoromethyl-aryl-diazirines that serve as linker molecules. Light activation of aryl-diazirino functions at 350 nm yields highly reactive carbenes and covalent coupling is achieved by simultaneous carbene insertion into both the ligand and the inert surface. Thus, reactive functional groups are not required on either the ligand or supporting material.

In still another approach, the microcantilever(s) and/or sensing tip(s) are coated with a thin layer of epoxy (Epotek 350) in order to cover the cantilever surface with an organic coating. A protocol for coating the such surfaces with the epoxy is described by Liu et al. (1996) J. Chromatogr. 723: 157-167. The coated microcantilever(s) can then be flushed with a specific binding moiety solution. The solution is allowed to react with the microcantilever(s) to bind the allergen or other binding moiety via hydrophobic and electrostatic interactions.

Blocking Protein Attachment.

In certain embodiments the microcantilever arrays comprise negative control microcantilevers that are treated to prevent attachment of protein or nucleic acids. Methods of treating surfaces to prevent protein attachment are known to those of skill in the art. Such methods include, but are not limited to coating the surface with materials such as pp4G, plasma-polymerized tetraglyme (see, e.g., Hanein et al. (2001) Sensors and Actuators B 81: 49-54), surfactants, and the like.

III. Analyte Detection/Quantification.

A) Sample Preparation.

Virtually any sample can be analyzed using the devices and methods of this invention. Such samples include, but are not limited to body fluids or tissues, water, food, blood, serum, plasma, urine, feces, tissue, saliva, oils, organic solvents, earth, water, air, or food products. In a preferred embodiment, the sample is a biological sample. The term “biological sample”, as used herein, refers to a sample obtained from an organism or from components (e.g., cells) of an organism. The sample may be of any biological tissue or fluid. Frequently the sample will be a “clinical sample” which is a sample derived from a patient. Such samples include, but are not limited to, sputum, cerebrospinal fluid, blood, blood fractions (e.g. serum, plasma), blood cells (e.g., white cells), tissue or fine needle biopsy samples, urine, peritoneal fluid, and pleural fluid, or cells therefrom. Biological samples may also include sections of tissues such as frozen sections taken for histological purposes.

Biological samples, (e.g. serum) can be analyzed directly or they may be subject to some preparation prior to use in the assays of this invention. Such preparation can include, but is not limited to, suspension/dilution of the sample in water or an appropriate buffer or removal of cellular debris, e.g. by centrifugation, or selection of particular fractions of the sample before analysis.

B) Sample Delivery into System.

The sample can be introduced into the devices of this invention according to standard methods well known to those of skill in the art. Thus, for example, the sample can be introduced into a microchannel through an injection port such as those used in high pressure liquid chromatography systems. In another embodiments the samples can be applied to a sample well that communicates to the microchannel. In still another embodiment the sample can be diffused, osmosed, or pumped into the microchannel. Means of introducing samples into channels are well known and standard in the capillary electrophoresis and chromatography arts.

C) Sample Reaction with the Binding Agent.

The analyte containing sample is provided to the microcantilever (sensor tip) in conditions compatible with or that facilitate binding of the analyte to the binding agent comprising the sensor tip. Thus, for example, where the sensor tip comprises an antibody or protein, reaction conditions are provided at the sensor tip that facilitate antibody binding. Such reaction conditions are well known to those of skill in the art (see, e.g., Techniques for using and manipulating antibodies are found in Coligan (1991) Current Protocols in Immunology Wiley/Greene, NY; Harlow and Lane (1989) Antibodies: A Laboratory Manual Cold SpringHarbor Press, NY; Stites et al. (eds.) Basic and Clinical Immunology (4th ed.) Lange Medical Publications, Los Altos, Calif., and references cited therein; Goding (1986) Monoclonal Antibodies: Principles and Practice (2d ed.) Academic Press, New York, N.Y.; and Kohler and Milstein (1975) Nature 256: 495-497, and the like).

Similarly, where the binding agent is a nucleic acid the sensor tip is maintained under conditions that facilitate binding of the target nucleic acid (analyte) to the binding agent comprising the sensor element(s). Stringency of the reaction can be increased until the sensor shows adequate/desired specificity and selectivity. Conditions suitable for nucleic acid hybridizations are well known to those of skill in the art (see, e.g., Berger and Kimmel, Guide to Molecular Cloning Techniques, Methods in Enzymology 152 Academic Press, Inc., San Diego, Calif.; Sambrook et al. (1989) Molecular Cloning—A Laboratory Manual (2nd ed.) Vol. 1-3, Cold Spring Harbor Laboratory, Cold Spring Harbor Press, NY; Ausubel et al. (1994) Current Protocols in Molecular Biology, Current Protocols, a joint venture between Greene Publishing Associates, Inc. and John Wiley & Sons, Inc.; U.S. Pat. No. 5,017,478; European Patent No. 0,246,864, and the like).

Once the analyte is bound to the binding moiety on the sensor tip , the sensor is optionally dehydrated and/or stored and/or read.

C) Analyte Detection/Quantitation.

Once introduced into the sensors of this invention, the sample is detected/quantified using standard methods to detect changes in electrical resistance or conductance and thereby deflection of the microcantilever(s). In certain embodiments the measurement results can be compared to a standard curve, i.e. a series or measurement results plotted as a function of analyte concentration, which permits determination of analyte concentration. The standard curve can be calculated by/stored in the device performing data acquisition.

IV. Cassettes.

In certain embodiments, this invention provides cassettes comprising one or more microcantilevers or microcantilever arrays according to this invention. In various embodiments, cassettes include microcantilever devices as described herein. In various embodiments the cassettes further comprise one or more microchannels and/or sample chambers and/or receiving ports, and in certain embodiments comprise a “lab on a chip”.

In certain embodiments, a cassette will comprise one or more microcantilever(s) bearing binding moieties (e.g. antibodies, nucleic acids, lectins, proteins etc.) that specifically or preferentially bind the analyte(s) of interest.

In certain preferred embodiment, a cassette or apparatus of the invention comprises a sample port and/or reservoir and one or more channels for sample delivery to the microcantilever(s) present in the cassette. The means for sample delivery can be stationary or movable and can be any known in the art, including but not limited to one or more inlets, holes, pores, channels, pipes, microfluidic guides (e.g., capillaries), tubes, and the like.

The channel(s) comprising the cassette can form a channel network, e.g., one or more channels, preferably microchannels. Typically included within a given channel network are channels or reservoirs in which the desired analysis is to take place (analysis channels). Also, optionally included are channels for delivering reagents, buffers, diluents, sample material and the like to the analysis channels.

The cassettes of this invention can optionally include separation channels or matrices for separating/fractionating materials transported down the length of these channels, for analysis, i.e., size or charged based fractionation of materials, e.g., nucleic acids, proteins etc. Suitable separation matrices include, e.g., GeneScan™ polymers (Perkin Elmer-Applied Biosystems Division, Foster City, Calif.). Alternatively, analysis channels are devoid of any separation matrix, and instead, merely provide a channel within which an interaction, reaction etc., takes place. Examples of microfluidic devices incorporating such analysis channels arc described in, e.g., PCT Application No. WO 98/00231, and U.S. Pat. No. 5,976,336.

Fluids can be moved through the cassette channel system by a variety of well known methods, for example: pumps, pipettes, syringes, gravity flow, capillary action, wicking, electrophoresis, electroosmosis, pressure, vacuum, etc. The means for fluid movement may be located on the cassette or on a separate unit.

The sample can be detected/quantified by all of the microcantilevers. Alternatively, a sample may be detected/quantified particular microcantilevers. Samples can be directed to the microcantilever(s) by an automatic pipetter for delivery of fluid samples directly to a sensor array, or into a reservoir in a cassette or cassette holder for later delivery directly to the microcantilever(s).

The cassettes of this invention can be fabricated from a wide variety of materials including, but not limited to glass, plastic, ceramic, polymeric materials, elastomeric materials, metals, carbon or carbon containing materials, alloys, composite foils, silicon and/or layered materials. Supports may have a wide variety of structural, chemical and/or optical properties. They may be rigid or flexible, flat or deformed, transparent, translucent, partially or fully reflective or opaque and may have composite properties, regions with different properties, and may be a composite of more than one material.

Reagents for conducting assays may be stored on the cassette and/or in a separate container. Reagents can be stored in a dry and/or wet state. In one embodiment, dry reagents in the cassette are rehydrated by the addition of a test sample. In a different embodiment, the reagents are stored in solution in “blister packs” which are burst open due to pressure from a movable roller or piston. The cassettes may contain a waste compartment or sponge for the storage of liquid waste after completion of the assay. In one embodiment, the cassette includes a device for preparation of the biological sample to be tested. Thus, for example, a filter may be included for removing cells from blood. In another example, the cassette may include a device such as a precision capillary for the metering of sample.

The cassette can also comprise more one layer of electrodes. Thus, for example, different electrode sets (e.g. arrays of microcantilevers) can exist in different lamina of the cassette and thus form a three dimensional array of microcantilevers.

V. Integrated Assay Device/Apparatus.

State-of-the-art chemical analysis systems for use in chemical production, environmental analysis, medical diagnostics and basic laboratory analysis are preferably capable of complete automation. Such total analysis systems (TAS) (Fillipini et al. (1991) J. Biotechnol. 18: 153; Gam et al (1989) Biotechnol. Bioeng. 34: 423; Tshulena (1988) Phys. Scr. T23: 293; Edmonds (1985) Trends Anal. Chem. 4: 220; Stinshoff et al. (1985) Anal. Chem. 57:114R; Guibault (1983) Anal. Chem Symp. Ser. 17: 637; Widmer (1983) Trends Anal. Chem. 2: 8) automatically perform functions ranging from introduction of sample into the system, transport of the sample through the system, sample preparation, separation, purification and detection, including data acquisition and evaluation.

Recently, sample preparation technologies have been successfully reduced to miniaturized formats. Thus, for example, gas chromatography (Widmer et al. (1984) Int. J. Environ. Anal. Chem. 18: 1), high pressure liquid chromatography (Muller et al. (1991) J. High Resolut. Chromatogr. 14: 174; Manz et al. (1990) Sensors & Actuators B1:249; Novotny et al., eds. (1985) Microcolumn Separations: Columns, Instrumentation and Ancillary Techniques J. Chromatogr. Library, Vol. 30; Kucera, ed. (1984) Micro-Column High Performance Liquid Chromatography, Elsevier, Amsterdam; Scott, ed. (1984) Small Bore Liquid Chromatography Columns: Their Properties and Uses, Wiley, N.Y.; Jorgenson et al. (1983) J. Chromatogr. 255: 335; Knox et al. (1979) J. Chromatogr. 186:405; Tsuda et al. (1978) Anal. Chem. 50: 632) and capillary electrophoresis (Manz et al. (1992) J. Chromatogr. 593: 253; Olefirowicz et al. (1990) Anal. Chem. 62: 1872; Second Int'l Symp. High-Perf. Capillary Electrophoresis (1990) J. Chromatogr. 516; Ghowsi et al. (1990) Anal. Chem. 62:2714) have been reduced to miniaturized formats.

Similarly, in certain embodiments, this invention provides an integrated assay device (e.g., a TAS) for detecting and/or quantifying one or more analytes using the microcantilevers, microcantilever arrays, or cassettes of this invention.

Thus, in certain embodiments, the cassettes of this invention are designed to be inserted into an apparatus, that contains means for reading one or more microcantilevers comprising a cassette of this invention. The apparatus, optionally includes means for applying one or more test samples to the microcantilevers or into a receiving port or reservoir and initiating detecting/quantifying one or more analytes. Such apparatus may be derived from conventional apparatus suitably modified according to the invention to conduct a plurality of assays based on a support or cassette. Modifications required include the provision for, optional, sample and/or cassette handling, multiple sample delivery, multiple electrode reading by a suitable detector, and signal acquisition and processing means.

Preferred apparatus, in accordance with this invention, thus can typically include instrumentation suitable for performing electrical resistance or conductance measurements and associated data acquisition and subsequent data analysis.

Preferred apparatus also provide means to hold cassettes, optionally provide reagents and/or buffers and to provide conditions compatible with binding agent/target analyte binding reactions.

The apparatus optionally comprises a digital computer or microprocessor to control the functions of the various components of the apparatus.

The apparatus also, optionally, comprises signal processing means. In one embodiment, and simply by way of example, the signal processing means comprises a digital computer for transferring, recording, analyzing and/or displaying the results of each assay.

The microcantilever arrays of this invention are particularly well suited for use as detectors in “low sample volume” instrumentation. Such applications include, but are not limited to genomic applications such as monitoring gene expression in plants or animals, parallel gene expression studies, high throughput screening, clinical diagnosis, single nucleotide polymorphism (SNP) screening, genotyping, and the like. Certain embodiments, include miniaturized molecular assay systems, so-called labs-on-a-chip, that are capable of performing thousands of analyses simultaneously.

VI. Kits

In certain embodiments, this invention provides kits for practicing the various methods described herein. The kits can include, for example, the microcantilever or microcantilever array alone, or incorporated in a microdevice providing sample chambers and the like and/or one or more evanescent field sample detectors as described herein.

Where the reservoirs are included in the kits, the reservoirs can, optionally, contain one or more buffers or bioactive agents (e.g., anti-IgE antibody) as required. In certain embodiments the bioactive agent is provided in a dry rather than a fluid form so as to increase shelf life.

The kits can optionally further comprise buffers, syringes, sample collectors and/or other reagents and/or devices to perform one or more of the assays described herein.

The components comprising the kits are typically provided in one or more containers. In certain preferred embodiments, the containers are sterile, or capable of being sterilized (e.g. tolerant of on site sterilization protocols).

The kits can be provided with instructional materials teaching users how to use the device of the kit. For example, the instructional materials can provide directions on utilizing the assay device (e.g. microcantilever array, and/or array reader) to diagnose one or more allergies in a subject (e.g., a human patient) (see, e.g., copending application U.S. Ser. No. 60/692,046, filed on Jun. 16, 2005, which is incorporated herein by reference).

While the instructional materials typically comprise written or printed materials they are not limited to such. Any medium capable of storing such instructions and communicating them to an end user is contemplated by this invention. Such media include, but are not limited to electronic storage media (e.g., magnetic discs, tapes, cartridges, chips), optical media (e.g., CD ROM), and the like. Such media may include addresses to internet sites that provide such instructional materials.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

### EXAMPLES

The following examples are offered to illustrate, but not to limit the claimed invention.

### Example 1

### Piezoresistive Cantilever Based Nanoflow and Viscosity Sensor for Microchannels

Microfluidic channels can be utilized as microreactors with wide range of applications, including molecular separations based upon micro/nanoscale physicochemical properties, targeting and delivery of small amount of fluids and molecules, and patterned/directed growth. Various applications involve a detailed understanding of phenomena associated with the microscale flow of liquids through these channels, including velocity, viscosity and miscibility. Here we demonstrate the design and application of a high mechanical sensitivity piezoresistive cantilever to measure flow properties in microfluidic channels.

In one illustrative prototype version, by milling down the legs of the piezoresistive cantilevers, we have achieved significantly higher mechanical sensitivity and smaller spring constant as determined by AFM. These cantilevers were used in microchannels to measure viscosity and flow rate of ethylene glycol over a range of concentrations as well as of low viscosity biologically relevant buffers with different serum levels. The sensor can be used alone or can be integrated in AFM systems for multidimensional study in micro and nanochannels.

Experimental Design

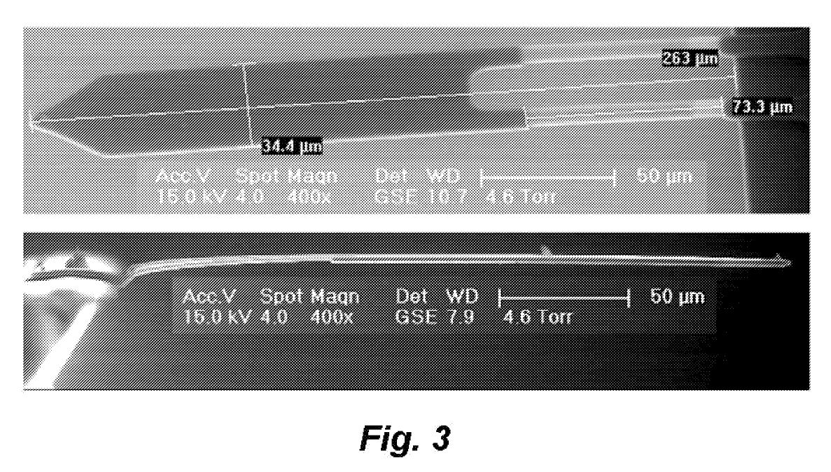

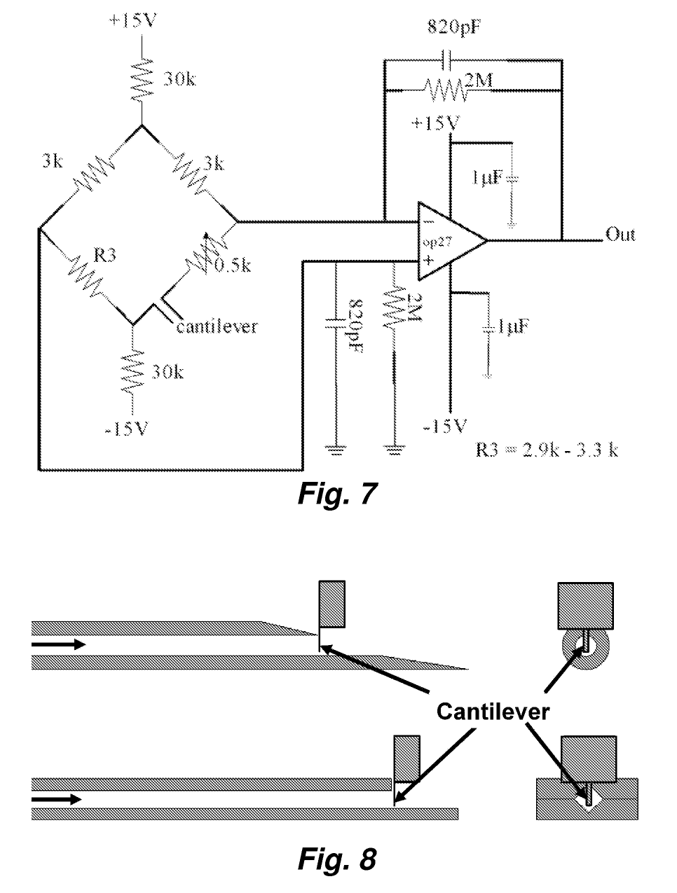

Piezoresistive cantilevers with a spring constant of 4 N m⁻¹, and a size of 265×50 microns in length and 2.7 micron thick were micro-machined using a focused ion beam (FIB International, Santa Clara, Calif., USA). The legs (see FIG. 3) were milled down to a thickness of 1.7 microns. The resulting spring constant ranged from 0.2 to 0.3 N m⁻¹. The resistance of implanted resistors ranged from 3 to 3.5 kV and was unchanged after ion beam milling. Gold wires were bonded to aluminum leads on the cantilever chip and connected to gold pads on a ceramic carrier. The lever was then used as one resistor in a full Wheatstone bridge (FIG. 7), whose output was fed to a differential amplifier based on a single OP-27 operational amplifier (Horowitz and Hill (1980) The Art of Electronics, Cambridge University Press, Cambridge). The bridge signal, amplified 600-fold, was read through a BNC-2110 data acquisition card using LabView 7 (National Instruments, Austin, Tex., USA).

The piezoresistive cantilever deflection was calibrated using an AFM. The ceramic carrier and cantilever were mounted on a home built tip holder for a Bioscope AFM (Veeco Metrology, Santa Barbara Calif.). The tip was engaged using the conventional optical beam deflection methods. The Z voltage on the scanner was then ramped to bend the cantilever over a defined distance, while reading out the voltage output of the amplified Wheatstone bridge.

For flow and viscosity measurements, a micromanipulator was used to position the cantilever in the tapered opening of a hypodermic needle with an inner diameter of 410 microns; alternatively a micro fabricated silicon flow channel was used with a rectangular cross-sectional area of 0.16 mm² (FIG. 8). This silicon flow channel was made using photo lithography and wet etching of silicon. Two half-channels were glued to each other to form a closed channel. Fluid was pumped using a syringe pump (KD Scientific, Holliston Mass.).

The metallic lines and pads on the cantilever chip were coated by a polymer for electrical insulation in the fluid. For flow sensing and viscosity measurements, cantilever deflection was measured at different flow speeds ranging from 0.05 to 3.5 ml/min. Reynolds number for the different solutions used ranged from 0.1 (Ethylene Glycol (Fisher Scientific, Hampton N.H.), low speed) to 120 (water, high speed), ensuring laminar flow conditions in all experiments (Kim et al. (2000) Jpn. J. Appl. Phys., Part 1, 39: 7134-7137).

Results and Discussion

Results of the ion beam milling process are shown in FIG. 1. The cantilevers, with a width of 50 microns (the top image in FIG. 3 is taken at 45 degree angle), has two legs that connect the paddle to the silicon base. After milling, the thickness was reduced from 2.7 to 1.7 micrometer in both legs, extending about 70-75 microns out from the base. The paddle was left unchanged. FIG. 3 also shows a side view of the same cantilever, which indicates a slight bending of the lever compared to the straight lever before milling.

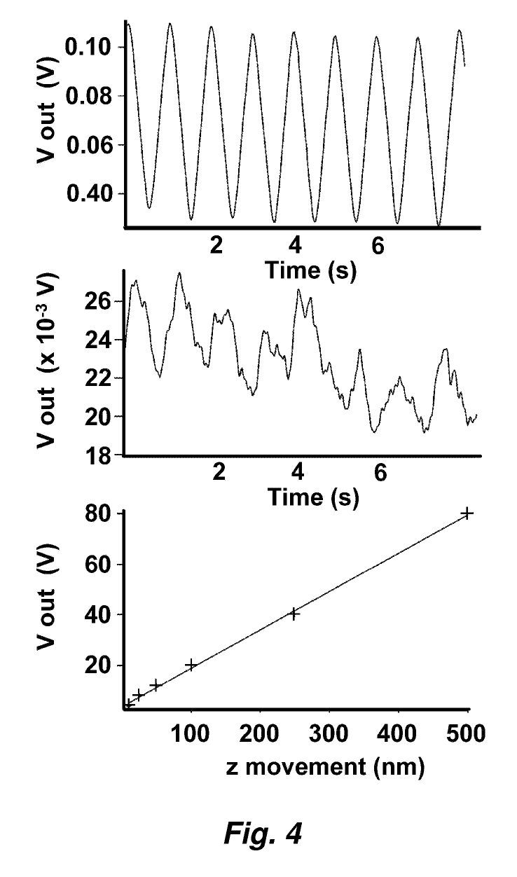

The cantilever bending was calibrated using the optical beam deflection of an AFM (Bioscope). For such study, a home made tip holder was machined to accommodate for the difference in cantilever angle necessary to engage the cantilever on a hard mica surface. The AFM scanner was then ramped up and down with a 1 Hz frequency using the force curve acquisition mode to control the vertical movement of the tip relative to the sample. FIG. 4 shows the output of the amplifier. The response of the cantilever is a linear function of the cantilever bending, with a slope of 0.15 mV/nm.

The minimum detectable deflection is determined by both the piezoresistive response of the cantilever (0.15 mV nm-¹) and the noise floor of the cantilever and amplifier circuitry. In our experiments, the noise floor was dominated by electrical pickup in the unshielded twisted pair wires between the amplifier and the cantilever, approximately 20 cm long. A strong 60 Hz component was filtered digitally, but as can be seen from the middle panel of FIG. 4, there remained approximately 1 mV p-p noise, corresponding to a deflection noise of about 6 nm p-p. This electrical noise was an order of magnitude higher than either the amplified equivalent input noise of the operational amplifier, or the amplified thermal noise in the resistors, as confirmed by experiments with a simple bridge resistor mounted directly on the amplifier circuit board. Thus, it is believed that locating the amplifier close to the cantilever and using proper shielding, the deflection sensitivity can be easily reduced to 0.6 nm. Further improvements are obtainable by optimization of the cantilever and bridge resistance, with values of 0.03 nm (see, Yu et al. (2002) J. Appl. Phys., 92: 6296-6301).

To monitor differences in the viscosity, a set of calibration fluids was used ranging from 1 cP (water) to 14 cP viscosity (ethylene glycol), all at 20° C. This is the most interesting range for biological fluids. The results are shown in FIG. 3. Fluid was pumped at 1 ml min⁻¹ through a stainless steel needle, in which the cantilever was inserted vertically (see Experimental). Generally, a stable readout was reached using these fluids after 60 seconds of flowing fluid past the cantilever. The time constant for water was around 12 seconds, and for ethylene glycol (EG) 25 seconds. The RC circuit of the amplifier used in our study had a bandwidth around 100 Hz. Thus, the observed time constant was likely due to a small thermal effect discussed below, and transient stretching of the plastic tubing used to connect the pump to the micro channel. In the absence of these effects, the system noise would easily support a time constant of one second, corresponding to the passage of 16 microlitres past the cantilever; sub-microlitre measurement volumes are reasonable under good conditions

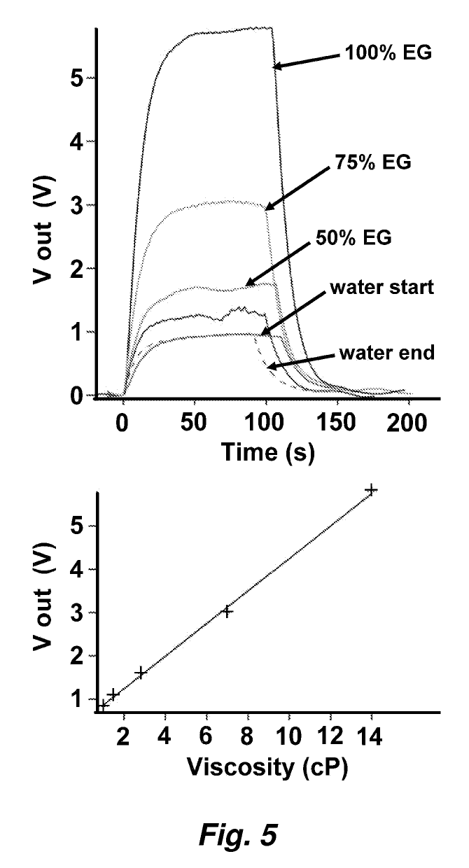

The bottom panel of FIG. 5 shows the voltage output versus the viscosity of different EG-water mixtures. The viscosity-voltage relationship appears linear, with a slope of 0.38 V cP⁻¹. The noise in this flow experiment was approximately 30 mV, significantly higher than in the deflection experiments done in air, and perhaps related to pressure fluctuations from the stepper-motor driven syringe pump. The corresponding viscosity noise floor is just below 0.1 cP.

Since there is some heat dissipation in the piezoresistor on the cantilever, we must consider the impact of cooling with various fluids and flow rates. At zero flow speed, we observed a difference of 250 mV when a cantilever was dipped alternately in water and ethylene glycol. If uncorrected, this would introduce an error of 0.66 cP, about 5%. To evaluate additional cooling due to flow, a lever was aligned parallel to the flow, to minimize bending. In this case, flow gave rise to ˜65 mV signal, roughly independent of flow speed above 50 mm/s, corresponding to a 1% error. Thus, thermal conduction and convection appear to impact cantilever response, and can be accounted for by calibration in the fluid to be measured, and perhaps in the microfluidic environment to be used.

Heat generation by the piezoresistor also warms the fluid to be measured, leading to another systematic error due to the temperature dependence of viscosity. While a complete thermal model is beyond the scope of this work, an upper estimate of the heating can be made by treating the cantilever as a spherical heat source of surface area equal to the area of the heat-generating portion of the actual cantilever, surrounded by a spherical cavity of radius equal to that of the actual microfluidic circuit. We also disregard convective heat transfer, and assume the walls of the fluidic circuit remain at ambient temperature. The temperature rise DT is then:

$$Δ T = \frac{{V}^{2}}{R} \frac{1}{4 π k} ( \frac{1}{{r}_{1}} - \frac{1}{{r}_{2}} )$$

(Petersen (1998) pp. 1378 in: Mechanical Engineers handbook, ed. M. Kutz, John Wiley and Sons, New York, 2^{nd} edn.), where k is the thermal conductivity of the fluid, r₁ is the effective radius of the heat source, r₂ is the radius of the flow channel, and V^{2/}R is the electrical power dissipation in the cantilever. In our experiments, the power dissipation was 750 microwatts, r₂ was 200 microns, and the effective radius r₁ was 15 microns. For water, with a thermal conductivity of 6 mW cm⁻¹° C.⁻¹, the upper estimate on the temperature rise is 6° C.; this would reduce the viscosity by about 0.14 cP, a drop of 14% and close to the noise limit. For ethylene glycol, the temperature rise would be about twice this value, but due to the higher temperature sensitivity, would produce a viscosity reduction of about 40%. This simple model overestimates the actual temperature rise, but does indicate that care must be taken in interpreting the data. One way to deal with the issue is to rely on calibrations. Another solution is to design the cantilevers so that the heat generating resistance is directly adjacent to the cantilever base so that the heat flows directly into the bulk silicon, whose thermal conductivity is almost 300 times greater than water. This also places the piezoresistor at the position of greatest strain.

After switching off the flow (around t=100 s), the voltage returned to the zero value. The sequence of solutions used in our study was the following: Water, 25% EG, 50% EG, 75% EG, 100% EG and finally water. The last water experiment resulted in exactly the same cantilever deflection as the first one, showing the reproducibility of the data. The slight instability in 25% and 50% EG is most likely caused by air bubbles, which were occasionally observed in these solutions. Changes in the viscosity measured at 1 ml/min can be determined within one minute, making the volume of needed fluid small. This could be further reduced by reducing the flow speed, especially for the higher viscosity fluids.

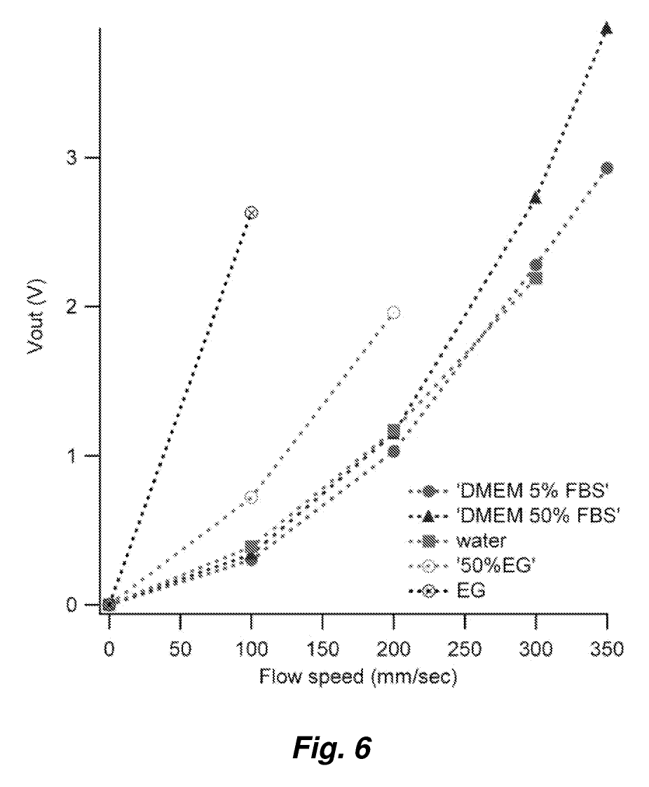

We then evaluated the effectiveness of these cantilevers for distinguishing biological buffers containing different levels of blood proteins. For such evaluation we used DMEM cell culture medium with 5% and 50% fetal bovine serum (FBS) in specially designed microfabricated silicon flow channel with a square cross-section of 0.16 mm₂ (see experimental section). FIG. 6 shows that for flow speeds up to 200 mm/sec, differences may be too small to detect. However, above this flow speed, the higher serum content buffer clearly shows a larger deflection/viscosity.

Conclusions

We have improved the sensitivity of existing piezoresistive cantilevers by milling the legs of the cantilever with a focused ion beam. The newly designed cantilever is sensitive to detect differences in viscosity at medium flow speeds (cm/s) in ethylene glycol solutions and biological buffers with different protein content. This demonstrates the feasibility to use the system as a flow and viscosity sensor for biological fluids with viscosity in the order of 1-5 cP.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A device for measuring physical and/or chemical properties of fluids or analytes in fluids at a nanoscale, said device comprising a piezoresistive microcantilever, said microcantilever having a spring constant of less than about 0.6 N/m.

2. The device of claim 1, wherein said microcantilever has a spring constant of less than about 0.4 N/m.

3. The device of claim 1, wherein said microcantilever has a spring constant that ranges from about 0.2 N/m to about 0.3 N/m.

4. The device of claim 1, wherein said microcantilever has a thickness of less than about 5.0 μm at least one location.

5. The device of claim 1, wherein said microcantilever has a thickness of less than about 3.0 μm at least one location.

6. The device of claim 1, wherein said microcantilever comprises at least one lever of length less than about 100 μm.

7. The device of claim 1, wherein said microcantilever comprises at least one lever of length less than about 75 μm.

8. The device of claim 1, wherein said microcantilever comprises at least one lever of length about 50 μm.

9. The device of claim 1, wherein said microcantilever comprises a material selected from the group consisting of silicon, carbon, germanium, tungsten, nickel, silicon nitride, and silicon oxide.

10. The device of claim 1, wherein said device further comprises a sensing tip attached to said microcantilever.

11. The device of claim 10, wherein said microcantilever has a spring constant at least five-fold less than said sensing tip.

12. The device of claim 10, wherein said microcantilever has a spring constant at least 10-fold less than said sensing tip.

13. The device of claim 10, wherein said sensing tip comprises a carbon nanotube.

14. The device of claim 10, wherein said sensing tip comprises a silicon structure.

15. The device of claim 10, wherein said sensing tip comprises a carbon cone, a carbon nanotube, a nanowire, diamond, silicon nitride, silicon oxide.

16. The device of claim 10, wherein said microcantilever and/or sensing tip is coated with a magnetic or non-magnetic metal layer.

17. The device of claim 19, wherein said metal layer functions as a chemical catalyst, a magnetic field sensor, or a capacitance sensor.

18. The device of claim 10, wherein said cantilever and/or sensing tip is functionalized with an agent selected from the group consisting of a hydroxyl, an amino, a carboxyl, and a thiol and/or a binding moiety selected from the group consisting of a nucleic acid, an antibody, a polypeptide, a sugar, a lectin, a carbohydrate, a cell, a receptor, a small organic molecule, an avidin, a streptavidin, a biotin, and a protein.

19. The device of claim 10, wherein said sensing tip is disposed in a microchannel.

20. The device of claim 1, wherein said device comprises a plurality of microcantilevers.

21. The device of claim 20, wherein said device comprises at least 10 microcantilevers.

22. The device of claim 20, wherein each of said plurality of microcantilevers bears a sensing tip.

23. The device of claim 22, different sensing tips are functionalized with agents that bind different analytes.

24. The device of claim 1, wherein said device is coupled to an instrument to measure electrical resistance changes in said microcantilever.

25. A piezoresistive microcantilever, said microcantilever having a spring constant of less than about 0.6 N/m.

26. The microcantilever of claim 25, wherein said microcantilever has a spring constant of less than about 0.4 N/m.

27. The microcantilever of claim 25, wherein said microcantilever has a spring constant that ranges from about 0.2 N/m to about 0.3 N/m.

28. The microcantilever of claim 25, wherein said microcantilever has a thickness of less than about 5.0 μm at least one location.

29. The microcantilever of claim 25, wherein said microcantilever has a thickness of less than about 3.0 μm at least one location.

30. The microcantilever of claim 25, wherein said microcantilever comprises at least one lever of length less than about 100 μm.

31. The microcantilever of claim 25, wherein said microcantilever comprises at least one lever of length less than about 75 μm.

32. The microcantilever of claim 25, wherein said microcantilever comprises at least one lever of length about 50 μm.

33. The microcantilever of claim 25, wherein said microcantilever comprises a material selected from the group consisting of silicon, carbon, germanium, tungsten, nickel, silicon nitride, and silicon oxide.

34. A method of measuring the flow rate or viscosity of a fluid, said method comprising:
contacting said fluid with a device comprising a piezoresistive microcantilever, said microcantilever having a spring constant of less than about 0.6 N/m; and
measuring the electrical resistance or electrical conductivity of said microcantilever wherein the electrical resistance or electrical conductivity provides a measure of the deflection of said microcantilever which provides a measure of flow rate and/or viscosity of said fluid.

35. The method of claim 34, wherein said fluid is in a microchannel.

36. A method of detecting the presence or quantity of an analyte in a solution, said method comprising:
contacting said solution with a device comprising a piezoresistive microcantilever, said microcantilever having a spring constant of less than about 0.6 N/m, wherein said microcantilever is attached to a sensing tip that is functionalized with an agent that binds said analyte; and
detecting deflection of said microcantilever wherein deflection of said microcantilever provides a measure of presence or amount of analyte bound to said tip.

37. The method of claim 36, wherein said detecting comprises detecting the conductance or resistivity of said microcantilever.

38. The method of claim 36, wherein said tip is functionalized with an agent selected from the group consisting of a hydroxyl, an amino, a carboxyl, and a thiol and/or a binding moiety selected from the group consisting of a nucleic acid, an antibody, a polypeptide, a sugar, a lectin, a carbohydrate, a cell, a receptor, a small organic molecule, an avidin, a streptavidin, a biotin, and a protein.

39. The method of claim 36, wherein said contacting is in a microchannel or microchamber.

40. A method of fabricating a piezoresistive microcantilever, said method comprising:
providing a device layer on a substrate wherein said device layer comprises a microcantilever;
micromachining said microcantilever to dimensions providing a spring constant of less than about 0.6 N/m.

41. The method of claim 40, wherein said micromachining comprises micro-milling using a focused ion beam.

42. The method of claim 40, wherein said microcantilever is machined to dimensions providing a spring constant of less than about 0.4 N/m.

43. The method of claim 40, wherein said microcantilever is machined to dimensions providing a spring constant that ranges from about 0.2 N/m to about 0.3 N/m.

44. The method of claim 40, wherein said microcantilever is machined to a thickness of less than about 5.0 μm at least one location.

45. The method of claim 40, wherein said microcantilever is machined to a thickness of less than about 3.0 μm at least one location.

46. The method of claim 40, wherein said microcantilever is machined to comprise at least one lever of length less than about 100 μm.

47. The method of claim 40, wherein said microcantilever is machined to comprise at least one lever of length less than about 75 μm.

48. The method of claim 40, wherein said microcantilever is machined to comprise least one lever of length about 50 μm.

49. The method of claim 40, wherein said method further comprises depositing a sensing tip attached to said microcantilever.

50. The method of claim 49, wherein said sensing tip comprises a carbon nanotube or a nanowire.
